(19) United States
(12) Patent Application Publication
(10) Pub. No.: US 2023/0001717 A1
(43) Pub. Date: Jan. 5, 2023

(54) DETERMINATION OF SIZE OF PRINTABLE MEDIUM

(71) Applicant: Hewlett-Packard Development Company, L.P., Spring, TX (US)

(72) Inventors: AiQiang Yang, Singapore (SG); Inn Chyun Goh, Singapore (SG); Yi Wan, Singapore (SG); Choon Siang Peck, Singapore (SG); Kok Chai Chong, Singapore (SG)

(21) Appl. No.: 17/754,385

(22) PCT Filed: Oct. 28, 2019
(86) PCT No.: PCT/US2019/058273

§ 371 Date: Mar. 31, 2022

(51) Int. Cl. B41J 13/32; B65H 1/06

(52) U.S. Cl. CPC B41J 13/32; B65H 1/06; B65H 2511/10

(57) ABSTRACT

Techniques for determination of size of printable medium are described. In an example, a printing device includes an adjuster that is movable based on a size of a printable medium to be fed to the printing device. A first element is coupled to the adjuster and moves with the adjuster to indicate a position of the adjuster. A second element is movable relative to the adjuster. A position signal indicative of a distance between the second element and the first element is generated. The position signal can be used to determine the size of the printable medium.

### BACKGROUND

A printing device, also referred to as a printer, may be used for printing an image, a document, or the like on a printable medium, such as a paper, fed to the printing device. The printable medium may come in various sizes, such as an A4 size, A3 size, B5 size, and the like. Accordingly, the printing device may have to determine the size of the printable medium prior to printing.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a printing device that can print on printable media of a plurality of sizes, according to an example implementation of the present subject matter;

FIG. 2 illustrates a printing device that can determine the size of a printable medium, according, to an example implementation of the present subject matter;

FIG. 3 illustrates a printing device having a print carriage mounted on a carriage rod, according to an example implementation of the present subject matter;

FIG. 4 illustrates the disposition of an adjuster leg and a print carriage in a printing device, according to an example implementation of the present subject matter;

FIG. 5(a) illustrates a position signal output by an analog Hall sensor for various distances from a first point on a carriage rod for various sizes of printable medium, according to an example implementation of the present subject matter;

FIG. 5(b) illustrates a position signal output by a digital Hall sensor for various distances from a first point on a carriage rod for various sizes of printable medium, according to an example implementation of the present subject matter;

FIG. 6 illustrates a perspective view of a portion of a printing device, according to an example implementation of the present subject matter;

FIG. 7 illustrates a perspective view of a portion of a printing device, according to an example implementation of the present subject matter; and

FIG. 8 illustrates a printing device that is to control movement of a print carriage, according to an example implementation of the present subject matter.

### DETAILED DESCRIPTION

A printing device may have to print on printable media of various sizes. Before printing on a printable medium, the printing device is to determine a size of the printable medium to ensure print quality. For example, consider a case where the printable medium is of B5 size and the printing device performs the print operation as if the printable medium is of A4 size, which is larger than B5 size. In such a case, the printing device may spray printing fluid outside the printable medium and may smear on the printable medium.

To determine the size of the printable medium, printing devices may utilize various techniques. In some cases, the techniques utilized for the determination of size are inaccurate. For instance; printable medium of one size, such as B5 size, may be determined as having another size, such as A4 size. Techniques that provide an accurate determination of size of the printable medium may be complex and expensive.

The present subject matter relates to determination of size of printable medium. With the implementations of the present subject matter, accurate and inexpensive determination of size of printable media can be achieved.

In accordance with an example implementation of the present subject matter, a printing device may include an adjuster that can be moved based on a size of a printable medium. For instance, the adjuster may be moved, depending on the size of the printable medium, to be placed alongside the printable medium. Accordingly, the distance of the adjuster from a fixed reference point may be used to determine the size of the printable medium, in an example, the adjuster may be disposed on a media tray and moved in a lateral direction of the media tray to be disposed adjacent to a side of the printable medium. In such a case, the fixed reference point may be at an end of the media tray.

The printing device may include a position sensing system having a first element and a second element. The first element may be coupled to the adjuster and the second element may be movable relative to the adjuster, To allow the second element to move relative to the adjuster, in an example, the second element may be coupled to a print carriage, which is used for supporting print cartridges.

The position sensing system may generate a position signal based on a position of the second element relative to the first element. The position signal may be generated, for example, by the first element or the second element. In an example, the first element may be a position indicator and the second element may be a sensing element that can sense the presence of the position indicator and can generate a position signal accordingly. Further, a magnitude of the position signal may depend on a distance between the first element and the second element. In an example, the position indicator may be a magnet and the sensing element may be a magnet sensing element, such as a Hall sensor, a magneto-resistive (MR) sensor, magneto-diode, or the like. Accordingly, a magnitude of a voltage signal output by the magnet sensing element depends on the distance of the magnet sensing element from the magnet.

The position signal can be used to determine the size of the printable medium. For instance, when a distance between the magnet sensing element and the magnet is less than a threshold distance, the magnitude of the position signal may be of a first value. The distance between the magnet sensing element and the magnet may be less than the threshold distance if, for example, the magnetic sensing element is vertically aligned with, such as vertically above or below, the magnet. Accordingly, a position of the magnet sensing element at which it outputs the position signal of the first value may be used to determine a position of the adjuster, and therefore, the size of the printable medium. A controller may receive the position signal and determine the size of the printable medium.

The present subject matter provides for an accurate determination of sizes of printable media. Further, the present subject matter can be used to determine several sizes of printable media. The present subject matter utilizes simple and cost-effective components for the size determination. Since the determination of the size is performed based on the magnitude of the position signal that varies during movement of the second element relative to the adjuster, an accurate size determination is achieved without the use of multiple stationary sensors. Further, since the second element is coupled to the print carriage, which is already utilized in printers, a separate component to move the sensing element may not be provided. Accordingly, the present subject matter can be implemented in printers in a simple manner, without a substantial change in their design or increase in cost of manufacturing.

The techniques of the present subject matter can be utilized in printers in scenarios where the printers are to automatically determine the size of the printable medium. In an example, upon determination of the size, the printing device may send the size information to a computing device that is to send a print command to the printing device. Accordingly, when the computing device sends the print command, the size information may be included in the print command.

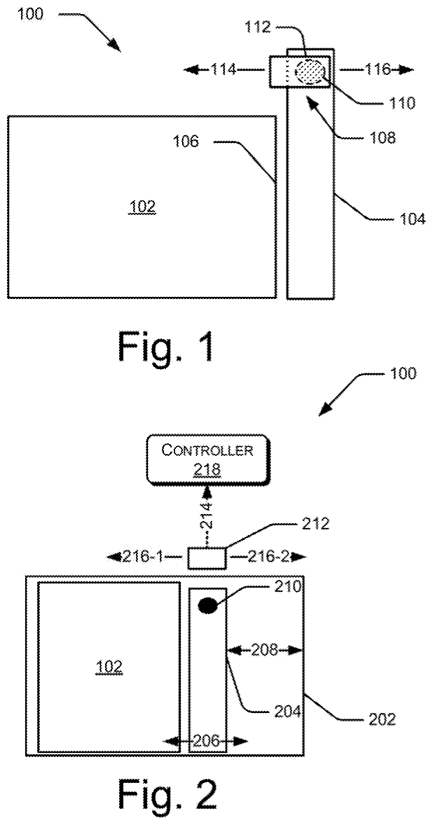

The present subject matter is further described with reference to FIGS. 1-8. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

Further, in the description provided below, the present subject matter is explained with reference to printing devices in which printable media are conveyed in a substantially C-shaped or L-shaped path. However, the present subject matter can be utilized in printing devices in which the printable media are conveyed in other types of paths as well.

Also, in the below description, the determination of the size of the printable media are explained with the help of magnets and magnet sensing elements. However, it is to be understood that the present subject matter can be implemented using other types of signal transmitters and signal sensors. For instance, a light emitting device can be used to emit a light signal, which can be sensed by an optical sensor for determining size of the printable media.

FIG. 1 illustrates a printing device 100 that can print on printable media of a plurality of sizes, according to an example implementation of the present subject matter. The printing device 100 can be fed with printable media of various sizes for being printed on. An example printable medium is a printable medium 102, which may be for example, a sheet material, such as a piece of paper, card stock, fabric, photo paper (on which photographs are printed), or the like. A size of a printable medium may refer to a length of the printable medium, a width of the printable medium, or a combination of both, and may include standard sizes referenced by nomenclature, such as A4 size, B5 size, and A3 size.

The printing device 100 may include an adjuster 104 that can be moved based on a size of the printable medium 102. For instance, the adjuster 104 can be moved towards the printable medium 102 to be positioned adjacent to a side of the printable medium 102. In FIG. 1, the adjuster 104 is shown slightly displaced from the printable medium 102 to clearly illustrate the printable medium 102 and the adjuster 104. In an example, the position of the adjuster 104 may be used to determine the size of the printable medium 102.

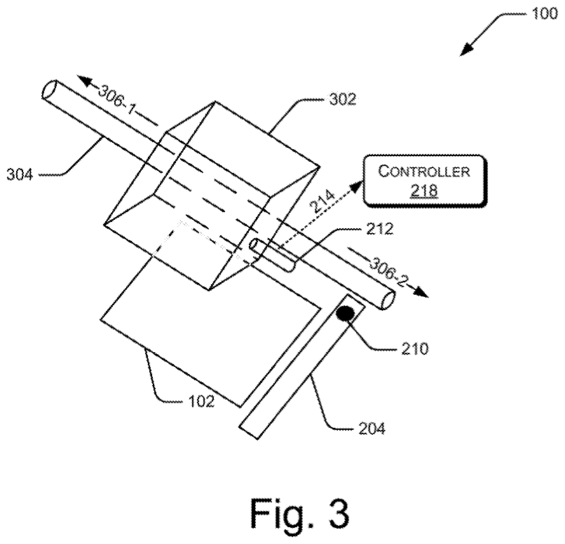

The printing device 100 may also include a position sensing system 108 for determining the size of the printable medium 102. The determination of the size may include determination of the length, the width, or both, of the printable medium 102. The position sensing system 108 includes a first element 110 and a second element 112. The first element 110 may be coupled to the adjuster 104 and may move along with the adjuster 104 to indicate a position of the adjuster 104. The second element 112 can move relative to the adjuster 104. For instance, the second element 112 can move in the directions indicated by arrows 114 and 116, To facilitate movement of the second element 112 relative to the adjuster 104, the second element 112 may be coupled to a movable element (not shown in FIG. 1), The movable element may be, for example, a print carriage of the printing device 100, as will be explained with reference to FIG. 3.

In an example, the second element 112 may be disposed above the adjuster 104 in a height-wise direction of the printing device 100. Accordingly, when the second element 112 moves relative to the adjuster 104, a portion of the adjuster 104 and the first element 110 may be below the second element 112 at some point during the movement of the second element 112, as illustrated in FIG.

The position sensing system 108 may generate a signal indicative of a distance between the first element 110 and the second element 112, Since the distance between the first element 110 and the second element 112 may change during movement of the second element 112 relative to the adjuster 104, in an example, a magnitude of the signal may vary during movement of the second element 112 relative to the first element 110. The signal may be generated, for example, by the first element 110 or the second element 112.

The signal can be used to determine a size of the printable medium 102. For instance, when a distance between the first element 110 and the second element 112 is less than a threshold distance, the magnitude of the signal may be of a first value. In an example, the threshold distance may be slightly more than the least possible distance between the first element 110 and the second element 112. Further, the distance between the first element 110 and the second element 112 may be less than the threshold distance if, for example, the second element 112 is vertically above the first element 110. Accordingly, a position of the second element 112 at which the signal has a magnitude equal to the first value may correspond to a position of the adjuster 104, and therefore, may indicate the size of the printable medium 102, Since the signal corresponds to the position of the adjuster 104, the signal may also be referred to as a position signal. The determination of the size of the printable medium 102 based on the position signal will be explained in greater detail in the subsequent paragraphs.

FIG. 2 illustrates the printing device 100 that can determine the size of the printable medium 102, according to an example implementation of the present subject matter.

The printing device 100 may include a media tray 202 to hold the printable medium 102 to be fed to the printing device 100 for printing. For instance, a user of the printing device 100 may place the printable medium 102 on the media tray 202. From the media tray 202, the printable medium 102 may be received inside a body of the printing device 100, where the printing operation may be performed. The media tray 202 may be a substantially planar structure.

An adjuster leg 204 may be disposed on the media tray 202, The adjuster leg 204 may correspond to, for example, the adjuster 104. The adjuster leg 204 may be moved along the media tray 202, such as in a direction indicated by an arrow 206 and be disposed alongside the printable medium 102. In an example, the position of the adjuster leg 204 on the media tray 202 indicates the size of the printable medium 102. For instance, once the adjuster leg 204 is positioned alongside the printable medium 102, a distance 208 between an end of the media tray 202 in the direction 206 and the adjuster leg 204 indicates the size of the printable medium 102, For example, a smaller distance 208 indicates a greater width of the printable medium 102, The adjuster leg 204 may be referred to as a width adjuster, as the adjuster leg 204 may be adjusted based on a width of the printable medium 102.

In addition to the adjuster leg 204, in an example, another adjuster leg (not shown in FIG. 2) may be disposed on the media tray 202. Accordingly, the adjuster leg 204 may be referred to as a first adjuster leg 204 and the other adjuster leg may be referred to as a second adjuster leg. The second adjuster leg may be displaced from the adjuster leg in the direction 206 and the printable medium 102 may be received between the first adjuster leg 204 and the second adjuster leg.

A position indicator 210 may be fixedly coupled to the adjuster leg 204. The position indicator 210 may indicate a position of the adjuster leg 204. In an example, the position indicator 210 may be a magnet, also referred to as the magnet 210. Accordingly, using a magnetic field of the magnet 210, the position of the adjuster leg 204 can be found. In an example, the position indicator 210 may correspond to the first element 110.

The printing device 100 may also include a sensing element 212 that can move relative to the adjuster leg 204. The sensing element 212 may be, for example, the second element 112. The sensing element 212 may sense a position of the position indicator 210 and may generate the position signal 214 based on the sensing. In an example, if the position indicator 210 is a magnet, the sensing element 212 may be a magnet sensing element and may be referred to as the magnet sensing element 212. A magnet sensing element may refer to an element that senses a magnetic field of a magnet and generates a signal based on a strength of the sensed magnetic field. Examples of the magnetic sensing element include a Hall-effect sensor, a magneto-resistive (MR) sensor, a magneto-diode, a magneto-transistor, and an eddy current sensor. In the below description, the magnet sensing element 212 will be explained with reference to a Hall-effect sensor as an example, also referred to as a Hall sensor.

The magnet sensing element 212 can generate the position signal 214 based on the magnetic field sensed. A strength of the magnetic field sensed increases with decrease in the distance between the magnet 210 and the magnetic sensing element 212. Accordingly, a magnitude of the position signal 214 may vary with the change in the distance between the magnet 210 and the magnet sensing element 212. As will be understood, the distance between the magnet 210 and the magnet sensing element 212 varies during movement of the magnet sensing element 212 relative to the adjuster leg 204 in a direction illustrated by arrows 216-1 and 216-2.

The printing device 100 may further include a controller 218. The controller 218 may be a processing resource (for example, one or more processors), to execute machine-readable instructions. The controller 218 may receive the position signal 214 and determine the size of the printable medium 102 based on the position signal 214. The determination of the size based on the position signal 214 may be achieved, for example, based on a magnitude of the position signal 214. For instance, a magnitude of the position signal 214 may vary during movement of the magnet sensing element 212 relative to the adjuster leg 204. Further, a magnitude equaling a first value may be achieved when the magnet sensing element 212 is aligned to the magnet 210. The controller 218 may determine the size based on a distance travelled by the magnet sensing element 212 from its starting point to produce the position signal 214 having the first value,

FIG. 3 illustrates the printing device 100 having a print carriage 302 mounted on a carriage rod 304, according to an example implementation of the present subject matter. The print carriage 302 may be used to support print cartridges (not shown in FIG. 3), which can supply ink for printing on the printable medium 102. The print carriage 302 may be mounted on the carriage rod 304 such that the print carriage 302 can slide along a length of the carriage rod 304, as illustrated by arrows 306-1 and 306-2.

In an example, the carriage rod 304 may be displaced from the adjuster leg 204 and the media tray 202 (not shown in FIG. 3) and can move relative to the adjuster leg 204. For instance, the carriage rod 304 may be displaced from the adjuster leg 204 in a height-wise direction of the printing device 100. Further, the print carriage 302 may face the adjuster leg 204 during its movement on the carriage rod 304. For instance, the print carriage 302 may face the adjuster leg 204 if it moves in the direction 306-2 from its position illustrated in FIG. 3.

In an example, the sensing element 212 may be coupled to the print carriage 302. Accordingly, the sensing element 212 can move along with the print carriage 302 when the print carriage 302 slides on the carriage rod 304. Such a movement of the sensing element 212 facilitates the sensing element 212 to move relative to the adjuster leg 204. When the sensing element 212 moves relative to the adjuster leg 204, the sensing element 212 can sense the position of the position indicator 210, as the position indicator 210 is attached to the adjuster leg 204. Based on the sensing, the sensing element 212 may generate the position signal 214. For instance, if the position indicator 210 is a magnet and if the sensing element 212 is a magnet sensing element, a strength of magnetic field of the magnet sensed by the sensing element 212 increases if the print carriage 302 moves in the direction 306-2 and decreases if the print carriage 302 moves in the direction 306-1 from its position illustrated in FIG. 3. Accordingly, the magnitude of the position signal 214 output by the sensing element 212 may also change during movement of the print carriage 302, Based on the position signal, the controller 218 may determine the size of the printable medium.

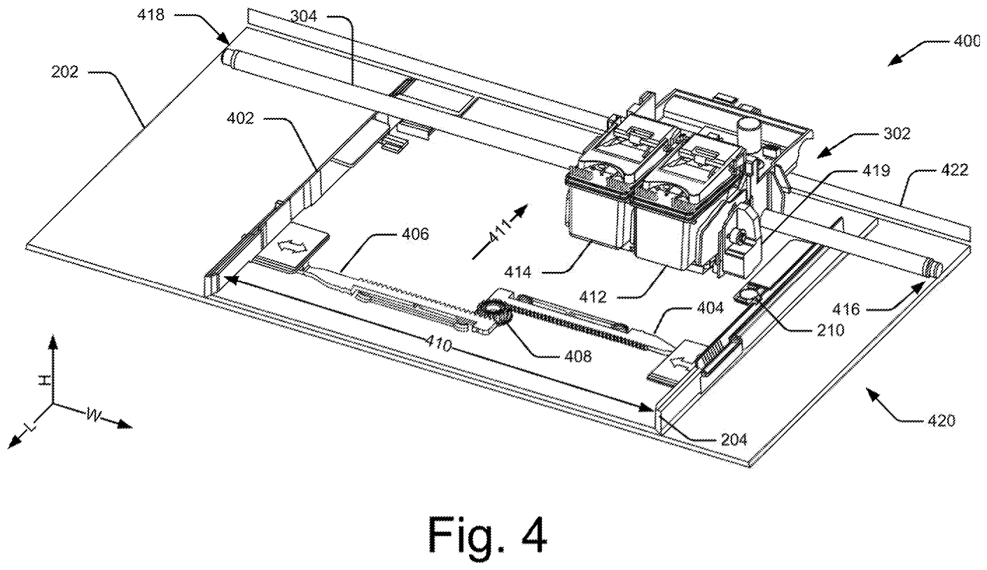

FIG. 4 illustrates the disposition of the adjuster leg 204 and the print carriage 302 in a printing device 400, according to an example implementation of the present subject matter. The printing device 400 may correspond to the printing device 100. Accordingly, components of the printing device 400 that are similar to that of the printing device 100 are represented by the same reference numerals. For instance, the media tray of the printing device 400 is represented by the reference numeral 202. Here, various components of the printing device 400, such as outer cover, chassis, and feed roller, have been obscured to clearly illustrate the adjuster leg 204, the print carriage 302, and other components coupled to them.

As illustrated, in addition to the adjuster leg 204, an additional adjuster leg 402 may be provided in the printing device 400. Accordingly, the adjuster leg 204 may be referred to as the first adjuster leg 204 and the additional adjuster leg 402 may be referred to as the second adjuster leg 402. The first adjuster leg 204 and the second adjuster leg 402 may be interlocked with each other. To interlock the adjuster legs, the first adjuster leg 204 may be coupled to a first arm 404 and the second adjuster leg 402 may be coupled to a second arm 406. Both the first arm 404 and the second arm 406 may be toothed and may be coupled to each other by a gear 408. The gear 408 meshes with the teeth of both the first arm 404 and the second arm 406. Accordingly, a movement of one of the adjuster legs causes the other adjuster leg to move. For instance, a movement of the first adjuster leg 204 towards the second adjuster leg 402 causes the first arm 404 to move along with the first adjuster leg 204. The movement of the first arm 404 causes rotation of the gear 408 due to the meshing between the teeth of the first arm 404 and the teeth of the gear 408. The rotation of the gear 408, in turn, causes the second arm 406 to move in a direction opposite the direction of movement of the first arm 404, i.e., towards the first arm 404. Accordingly, the second adjuster leg 402 moves towards the first adjuster leg 204. Conversely, the movement of the first adjuster leg 204 away from the second adjuster leg 402 causes the second adjuster leg 402 to, move in a direction away from the first adjuster leg 204. Accordingly, the interlocking of the first adjuster leg 204 and the second adjuster leg 402 causes them to move relative to each other, i.e., towards and away from each other.

In an example, the first adjuster leg 204 and the second adjuster leg 402 may be disposed on the media tray 202 and may be displaced from each other in a lateral direction 410 of the media tray 202. Further, the movement of the adjuster legs relative to each other, as explained above, may be in the lateral direction 410 of the media tray 202. The lateral direction 410 may also be referred to as a widthwise direction 410 of the media tray 202, which may be the same as a widthwise direction ‘W’ of the printing device 400.

The media tray 202 may receive the printable medium 102 (not shown in FIG. 4) for printing During the course of operation of the printing device 400, a user may first remove the media tray 202 from the printing device 400 and place the printable medium 102 on the media tray 202. The printable medium 102 may be placed such that it is positioned at the center of the media tray 202. Subsequently, the position of one of the adjuster legs may be adjusted based on the size, such as width, of the printable medium 102. The adjustment of the position may be such that the first adjuster leg 204 is adjacent to one side of the printable medium 102 and the second adjuster leg 402 is adjacent to another side of the printable medium 102. For instance, if, upon placing the printable medium 102 on the media tray 202, it is found that the two adjuster legs are not adjacent to the printable medium 102, the user may move one of the adjuster legs, such as the first adjuster leg 204, in the lateral direction 410 towards the printable medium 102. Since the other adjuster leg, such as the second adjuster leg 402, is interlocked with the adjuster leg, the other adjuster leg also moves in the lateral direction 410 towards the printable medium 102. Thereafter, the media tray 202 may be inserted into the printing device 400.

Accordingly, upon completion of the adjustment of the positions of the adjuster legs and insertion of the media tray 202, the printable medium 102 is enclosed by the two adjuster legs on its two opposite sides. Further, a position of the adjuster legs may indicate the size of the printable medium 102. For instance, once the adjuster legs are positioned adjacent to the sides of the printable medium 102, a distance of an adjuster leg from a fixed reference point on the media tray 202 may indicate the size of the printable medium 102. The fixed reference point may be, for example, at an end of the media tray 202 in the lateral direction 410.

Once the printable medium 102 is placed on the media tray 202 and the positions of the adjuster legs are adjusted, upon receiving a print command, for example, from a computing device (not shown in FIG. 4), the printable medium 102 may be conveyed inside the body of the printing device 400 in a direction 411. The direction 411 may be referred to as a conveyance direction. The conveyance direction 411 may be perpendicular to the lateral direction 410. Subsequently, the printable medium 102 may move upwards by moving around a roller (not shown in FIG. 4). Accordingly, the printable medium 102 is conveyed in a substantially C-shaped path in the printing device 400 for printing. Thus, the printing device 400 may be referred to as a C-path printing device.

The printing device 400 may also include the print carriage 302. In an example, the print carriage 302 may be a frame-like structure and may have stalls in which print cartridges may be received and supported. For instance, the print carriage 302 may include a first stall in which a first print cartridge 412 and a second stall in which a second print cartridge 414 may be supported. A print cartridge may be a fluid-jet precision-dispensing device or fluid ejector structure that precisely dispenses fluid, such as ink and liquid toner, on a printable medium, such as the printable medium 102. In an example, the print cartridge may be single-color ink cartridge. The print cartridge may include a fluid ejection die (not shown in FIG. 4) that ejects drops of fluid, such as ink and liquid toner, through a plurality of orifices or nozzles (not shown in FIG. 4) toward the printable medium to print onto the printable medium. The fluid ejection die may be, for example, a print head, such as a thermal inkjet (TIJ) print head or a piezoelectric inkjet print head.

The print carriage 302 may be mounted on the carriage rod 304 and may slide along the length of the carriage rod 304. The print carriage 302 may slide between a first point and a second point on the carriage rod 304. The first point and the second point may be, for example, ends 416 and 418 of the carriage rod 304. In an example, the carriage rod 304 may be disposed above the media tray 202 in a height-wise direction ‘H’ of the printing device 400. Further, the carriage rod 304 may extend in length parallel to the lateral direction 410. Accordingly, when the print carriage 302 slides on the carriage rod 304, the print carriage 302 travels in a direction parallel to the lateral direction 410.

To determine the size of the printable medium 102, the printing device 400 may include the magnet 210 and the magnet sensing element 212 (not shown in FIG. 4). The magnet sensing element may be housed in a sensor cover 419. In an example, the magnet 210 may be disposed on the first adjuster leg 204. Further, the sensor cover 419 may be coupled to the print carriage 302. The coupling of the sensor cover 419, housing the magnet sensing element 212, to the print carriage 302 causes a coupling between the magnet sensing element 212 and the print carriage 302.

The magnet 210 may be disposed on the first adjuster leg 204 such that the magnet 210 faces upwards. Further, the magnet sensing element 212 may be coupled such that it faces downwards. Accordingly, when the print carriage 302 travels on the carriage rod 304, the magnet sensing element 212 may be vertically above the magnet 210, and the magnet 210 may face the magnet sensing element 212 at a position of the print carriage 302 on the carriage rod 304. For other positions of the print carriage 302 on the carriage rod 304, the magnet sensing element 212 may not be vertically aligned with the magnet 210, For instance, for the other positions of the print carriage 302, the magnet sensing element 212 may be separated from the magnet 210 in the widthwise direction W, in addition to being separated in the height-wise direction ‘H’. Accordingly, a distance between the magnet 210 and the magnet sensing element 212 is the least when the magnet sensing element 212 is vertically above the magnet 210.

The magnet sensing element 212 may generate the position signal 214 (not numbered in FIG. 4) based on its distance from the magnet 210. The distance between the magnet 210 and the magnet sensing element 212, or more generally, the distance between the position indicator 210 and the sensing element 212, may also be referred to as a sensing distance. The position signal 214 may be, for example, an electrical signal, such as a voltage signal.

The magnitude of the position signal 214 varies with the change in sensing distance. In an example, the magnitude of the position signal 214 may be inversely proportional to the sensing distance. Accordingly, the magnitude of the position signal 214 output by the magnet sensing element 212 may be highest when the magnet sensing element 212 is vertically above the magnet 210. In another example, the magnitude of the position signal 214 may be directly proportional to the sensing distance.

In both the above examples, a magnitude of the position signal 214 output obtained when the magnet sensing element 212 is vertically above the magnet 210 may be different from that obtained for other positions of the magnet sensing element 212. The magnitude of the position signal 214 when the magnet sensing element 212 is vertically above the magnet 210 may be referred to as being of a first value.

Since the magnitude of the position signal 214 varies with the change in the sensing distance and since the sensing distance changes during the movement of the print carriage 302 along the carriage rod 304; the magnitude of the position signal 214 varies during the movement of the print carriage 302 along the carriage rod 304. Accordingly, the position of the first adjuster leg 204, on which the magnet 210 is disposed, may be determined based on the magnitude of the position signal 214 during the movement of the print carriage 302 along the carriage rod 304, as will be explained below:

Consider that the print carriage 302 is at a first point, such as the first end 416, of the carriage rod 304. To determine the size of the printable medium 102, the controller 218 may instruct the print carriage 302 to move along the carriage rod 304 till a second point, such as the second end 418. During such a movement of the print carriage 302, the magnitude of the position signal 214 generated by the magnet sensing element 212 changes as the sensing distance changes. While the magnitude of the position signal 214 changes, for one position of the print carriage 302 on the carriage rod 304, the sensing distance becomes less than the threshold distance, and the magnitude becomes equal to the first value. The sensing distance becomes less than the threshold distance when the distance between the magnet 210 and the magnet sensing element 212 is the minimum possible value of the sensing distance. Subsequently, as the print carriage 302 moves away from that position, the sensing distance increases, and the magnitude changes. The distance of the position at which the magnitude equaled the first value corresponds to the position of the magnet 210. The determination of the position of the magnet 210 based on magnitudes of the position signal 214 and the distance of the print carriage 302 from the first point will be explained below with the help of an example.

In an example, the magnet sensing element 212 may be an analog Hall sensor, Table 1 below illustrates voltage values output by the analog Hall sensor for various distances of the print carriage 302 from the first end 416.

TABLE 1
Example voltage values obtained for various distances
of the print carriage 302 from the first end 416:

| Distance of print carriage 302 | Output voltage from the |
|---|---|
| from first end 416 (in mm) | Analog Hall sensor (in V) |
| 10 | 0 |
| 20 | 0 |
| 30 | 0 |
| 40 | 0 |
| 50 | 0.22 |
| 60 | 0.46 |
| 70 | 0.68 |
| 80 | 0.40 |
| 90 | 0.2 |
| 100 | 0 |
| 110 | 0 |

From the above table, it can be seen that the output voltage increases and reaches a peak value (0.68 V) as the print carriage 302 moves away from the first end 416 till the print carriage is 70 mm away from the first end 416. Beyond the distance of 70 mm, the output voltage decreases from the peak value for further increase in the distance. The peak value may be the first value of position signal 214 explained above. Such a pattern of output voltage may be obtained because the analog Hall sensor may be closest to the magnet 210, i.e., the sensing distance may be less than the threshold distance, when the print carriage 302 is 70 mm away from the first end 416. For instance, the analog Hall sensor may be vertically above the magnet 210 when the print carriage 302 is 70 mm away from the first end 416.

Since the media tray 202 extends in width parallel to the carriage rod 304, the distance of the print carriage 302 from the first end 416 may correspond to another distance from a lateral end 420 of the media tray 202. For instance, if the first end 416 is vertically above a point on the lateral end 420, the point 70 mm away from the first end 416 is vertically above the point that is 70 mm away from the lateral end 420. Therefore, the magnet 210 may be determined to be near the point that is 70 mm away from the lateral end 420. Since the magnet 210 is disposed on the first adjuster leg 204, the position of the first adjuster leg 204 on the media tray 202 may also be deduced. Further, since the position of the first adjuster leg 204 on the media tray 202 indicates the size of the printable medium 102, the size of the printable medium 102 can be determined.

As will be understood from the above, the distance from the first end 416 at which the peak output of the position signal 214 is obtained (70 mm in the above example) corresponds to a size of the printable medium. Such a distance, at which the peak output is obtained, may be referred to as a peak distance. Accordingly, in an example, the controller 218 may utilize a first look-up table (not shown in FIG. 4) having a mapping between various peak positions and their corresponding sizes of printable media. Accordingly, upon determining the peak position during the travel of the print carriage 302 between the first point and the second point, the controller 218 can determine the size of the printable medium 102 using the first look-up table. The first look-up table may be stored, for example, in a memory (not shown in FIG. 4) of the printing device 400.

In the above example, a single value (0.68 V) of position signal s used for determining the position of the magnet 210. However, in some cases, a range of values may be utilized. For instance, a position signal in a range between a second value and the first value may be used for determining the position of the magnet 210. For example, a position signal of magnitude between 0.60 V and 0.68 V may be specified as indicating a sensing distance less than the threshold distance. Therefore, even if the magnitude of the position signal does not reach the value of 0.68 V, for example, due to ageing of components or other reasons, the position of the magnet 210 can be determined. In a further example, even if the magnitude of the position signal does not reach a peak value, the peak value may be deduced from discrete values (0.22 V, 0.46 V, . . . in the above table) using a curve fitting technique, According to the curve fitting technique, a best fit curve is fitted on the discrete values. On the best fit curve, the peak value may be determined. Further, the peak distance corresponding to the peak value may also, be determined. Based on the peak distance, the size of the printable medium may be determined.

In an example, instead of the analog Hall sensor, a digital Hall sensor may be used as the magnet sensing element 212. The digital Hall sensor may output the position signal 214 as a binary value. For instance, if the sensing distance is less than the threshold distance, the position signal 214 may be ‘high’ or ‘1’ and if the sensing distance is greater than the threshold distance, the position signal 214 may be ‘low’ or ‘0’. In accordance with the example, the first value of the position signal 214 may be the ‘high’ value and the second value of the position signal 214 may be the ‘low’ value. The value ‘1’ may correspond to a voltage value, such as 5 V, while the value ‘0’ may correspond to another voltage value, such as 0 V. Table 2 below illustrates the position signal 214 output by the digital Hall sensor for various distances of the print carriage 302 from the first end 416, according to an example:

TABLE 2
Output of digital Hall sensor obtained for various distances
of the print carriage 302 from the first end 416:

| Distance of print carriage 302 | Output of the Digital Hall |
|---|---|
| from first end 416 (in mm) | sensor |
| 10 | 0 |
| 20 | 0 |
| 30 | 0 |
| 40 | 0 |
| 50 | 1 |
| 60 | 1 |
| 70 | 1 |
| 80 | 1 |
| 90 | 1 |
| 100 | 0 |
| 110 | 0 |

From the above table, it can be seen that the digital Hall sensor outputs a position signal 214 of for some distances from the first end 416, while for the other distances, the output is ‘0’, Since the value of ‘1’ is output for multiple distances, to determine the distance that corresponds to the position of the magnet 210, the controller 218 may compute an average of such distances. In this case, the average of the distances, i.e., (50+60+70+80+90)/5, equals 70. Accordingly, the point that is 70 mm away from the first end 416 may be determined as the position corresponding to the position of the magnet 210. Based on the position of the magnet 210, the size of the printable medium 102 may be determined as explained above. In an example, to determine the size of the printable medium 102, the controller 218 may utilize a second look-up table (not shown in FIG. 4), The second look-up table may have different average distances from the first end 416 for which the output ‘1’ is obtained (e.g., the distance 70 mm in the above example) and the corresponding sizes of printable medium. The second look-up table may be stored in the memory of the printing device 400.

In the above examples, the sizes of the printable media are determined based on the distance travelled by the print carriage 302 from the first point. To determine the distance travelled by the print carriage 302, the printing device 100 may include an encoder strip 422. The encoder strip 422 may run parallel to the carriage rod 304. Further, a portion of the print carriage 302 extends rearwardly and over the encoder strip 422. The encoder strip 422 may include graduations, which may be in the form of opaque lines marked on the encoder strip 422. Such graduations may be optically sensed to determine the position of the print carriage 302, For instance, a reader (not shown in FIG. 4) of the encoder strip 422 may produce a signal as the print carriage 302 changes location across the encoder strip; facilitating determination of the distance traversed by the print carriage 302.

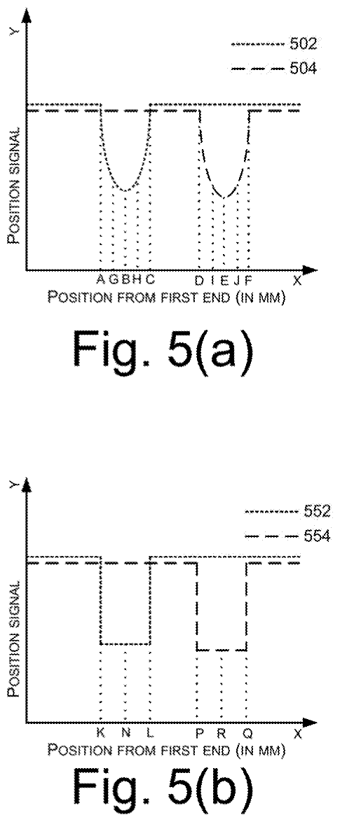

FIG. 5(a) illustrates the position signal 214 output by the analog Hall sensor for various distances from the first point for various sizes of printable medium, according to an example implementation of the present subject matter, Here, the first pattern 502 corresponds to a printable medium of a first size, such as A4 size, and the second pattern 504 corresponds to a printable medium of a second size, such as A5 size. Here, the first pattern 502 and the second pattern 504 are shown slightly offset in the y-axis to distinguish between the two patterns.

Although, in the analog Hall sensor example explained above, the magnitude of the position signal 214 was explained as increasing with the decrease in the sensing distance, in some cases, the magnitude may decrease with decrease in the sensing distance. For instance, as illustrated, the position signal 214 is substantially same for a distance from the first end 416 between 0 mm and ‘A’ mm. From the distance ‘A’ mm, the magnitude of the position signal 214 starts dropping, and at a distance ‘B’ mm, the magnitude reaches a minimum value. After the distance ‘B’ mm, the magnitude of the position signal 214 starts increasing. Once the distance increases beyond ‘C’ mm, the magnitude again becomes equal to that obtained between 0 mm and ‘A’ mm. Here, the sensing distance may be less than the threshold distance when the distance of the print carriage 302 from the first end 416 is B′ mm. Further, the first value of the position signal 214 may be the value obtained at the distance ‘B’ mm.

As for the second pattern 504, the position signal 214 is substantially same for a distance from the first end 416 between 0 mm and U mm. From the distance ‘D’ mm, the magnitude of the position signal 214 starts dropping, and at a distance ‘E’ mm, the magnitude reaches a minimum value. After the distance ‘E.’ mm, the magnitude of the position signal 214 starts increasing. Once the distance increases beyond ‘F’ mm, the magnitude again becomes equal to that obtained between 0 mm and ‘D’ mm. Here, the sensing distance may be less than the threshold distance when the distance of the print carriage 302 from the first end 416 is ‘E’ mm. Further, the first value of the position signal 214 may be the value obtained at the distance ‘E’ mm.

From the first pattern 502 and the second pattern 504, it can be seen that the position signal 214 of the first value is obtained for different distances from the first end 416 for different sizes of printable medium. The distances for which the position signal 214 of the first value is obtained for different sizes may be stored in the first look-up table, as shown below:

First look-up table

| Distance for which position | Size of printable |
|---|---|
| signal has a first value (in mm) | medium |
| B | A4 |
| E | A5 |

Therefore, once the print carriage 302 completes the travel between the first end 416 and the second end 418, if it is determined that the position signal 214 of the first value is obtained fora distance between of ‘B’ mm, the size of the printable medium may be determined as A4. Similarly, if it is determined that the position signal 214 of the first value is obtained for a distance between of ‘E’ mm, the size of the printable medium may be determined as A5. In an example, in the first look-up table, instead of specifying a single distance as corresponding to a size, a range of distances may be specified. For instance, instead of mentioning ‘B’ mm as the distance corresponding to the A4 size, a range of ‘G’ mm ‘H’ mm may be specified in the first look-up table. Accordingly, if the first value of the position signal 214 is obtained for any distance between ‘G’ mm and ‘H’ mm, the size of the printable medium may be determined as A4 size. Similarly, a range of ‘I’ mm-‘J’ mm may be specified in the first look-up table corresponding to the A5 size. The specification of a range of distances corresponding to a size ensures that minor variations in the distance corresponding to the first value are accounted for. For instance, even if the first value is received for a distance between T mm and ‘J’ mm, the size may be determined to be A5.

FIG. 5(b) illustrates the position signal 214 output by the digital Hall sensor for various distances from the first point for various sizes of printable medium, according to an example implementation of the present subject matter. Here, the third pattern 552 corresponds to a printable medium of a first size, such as A4 size, and the fourth pattern 554 corresponds to a printable medium of a second size, such as A5 size. Here, the third pattern 552 and the fourth pattern 554 are shown slightly offset in the y-axis to distinguish between the two patterns.

As illustrated, the position signal 214 is the same for a distance from the first end 416 between 0 mm and ‘K’ mm. At the distance ‘K’ mm, the magnitude of the position signal 214 suddenly drops. The position signal 214 obtained till the distance of mm may correspond to the ‘high’ value. Further, the decreased value obtained after the distance of ‘K’ mm may correspond to the ‘low’ value. The position signal 214 remains at the decreased value till a distance of ‘L’ mm, beyond which the magnitude again becomes equal to that obtained between ‘K’ mm and ‘N’ mm. An average of ‘L’ mm and ‘K’ mm ((L+K)/2) may be ‘N’ mm. Here, the sensing distance may be less than the threshold distance when the distance of the print carriage 302 from the first end 416 is ‘N’ mm. Further, the first value of the position signal 214 may be the value obtained for the distance between ‘K’ mm and ‘N’ mm. An average of the distances between which the magnitude equals the first value may be referred to as first value average distance.

As for the fourth pattern 554, the position signal 214 is the same for a distance from the first end 416 between 0 mm and ‘P’ mm. At the distance ‘P’ mm, the magnitude of the position signal 214 suddenly drops. The position signal 214 remains at the decreased value till a distance of ‘0’ mm, beyond which the magnitude again becomes equal to that obtained between 0 mm and ‘P’ mm. An average of ‘P’ mm and ‘Q’ mm may be ‘R’ mm. Here, the sensing distance may be less than the threshold distance when the distance of the print carriage 302 from the first end 416 is ‘R’ mm. Further, the first value of the position signal 214 may be the value obtained for the distance between ‘P’ mm and ‘Q’ mm.

The first value average distance for which the magnitude of the position signal 214 equals the first value for different sizes may be stored in a second look-up table, as shown below:

Second look-up table

| First value average distance | |
|---|---|
| for which position signal has a | |
| first value (in mm) | Size of printable medium |
| N | A4 |
| R | A5 |

Therefore, once the print carriage 302 completes the travel between the first end 416 and the second end 418, the first value average distance is computed. If the first value average distance is ‘N’ mm, the size of the printable medium may be determined as A4. Similarly, if the first value average distance is ‘R’ mm, the size of the printable medium may be determined as A5. In an example, in the second look-up table, instead of specifying a single distance as corresponding to a size, a range of distances may be specified. For instance, instead of mentioning ‘N’ mm as the first average distance corresponding to the A4 size, a range of mm ‘K’-‘L’ mm may be specified in the second look-up table. Accordingly, if the first average distance is determined to be between ‘K’ mm and ‘L’ mm, the size of the printable medium may be determined as A4 size. Similarly, a range of ‘P’ mm-‘Q’ mm may be specified in the second look-up table as corresponding to the A5 size.

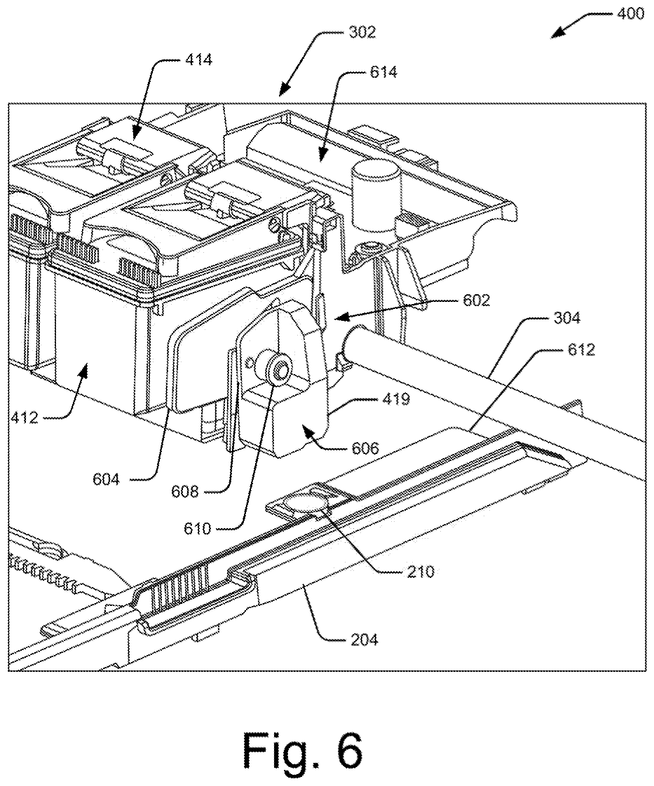

FIG. 6 illustrates a perspective view of a portion of the printing device 400, according to an example implementation of the present subject matter. As explained earlier, the printing device 400 includes the print carriage 302. The print carriage 302 includes a chassis 602, also referred to as carriage chassis 602, that supports side walls, such as a first side-wall 604 and a second side-wall (not shown in FIG. 6). Between the side-walls, a stall is formed, in which the print cartridges 412 and 414 are received. The carriage chassis 602 extends in a rearward direction, i.e., away from the side-walls. In the rearward extension, an, opening (not visible in FIG. 6) is formed that extends in the axial direction of the carriage chassis 602. The opening has dimensions corresponding to the carriage rod 304. For instance, the opening has the same diameter as the carriage rod 304. Therefore, using the opening, the print carriage 302 can be mounted on the carriage rod 304. Such a mounting of the print carriage 302 on the carriage rod 304 slidably supports the print carriage 302 on the carriage rod 304. The print carriage 302 may be coupled to an endless belt that is driven by a motor (not shown in FIG. 6) to slide the print carriage 302 along the carriage rod 304.

As explained earlier, the magnet sensing element 212 may be housed in the sensor cover 419. The sensor cover 419 has a box portion 606 in which the magnet sensing element 212 is housed. In addition, the sensor cover 419 has a side plate 608 enclosing the box portion 606 on one side. The sensor cover 419 may be coupled to the first side-wall 604. Such a coupling may be achieved, for example, by fastening the side plate 608 with the first side-wall 604 using a fastener 610. Accordingly, the sensor cover 419 may be projecting sideways from the print carriage 302. Further, the sensor cover 419 may be in front of the carriage rod 304.

The magnet 210 may be disposed on the first adjuster leg 204, as explained earlier. In an example, the first adjuster leg 204 includes a lateral extension 612 that extends in the widthwise direction 410, and the magnet 210 may be disposed on the lateral extension 612. In an example, the lateral extension 612 has a magnet receiving area (not numbered in FIG. 6) having a shape corresponding to the magnet 210 for receiving the magnet 210, The disposition of the magnet 210 on the lateral extension 612 allows the magnet 210 to face upwards, so that the magnetic field of the magnet 210 can be sensed by the magnet sensing element 212.

In an example, to supply the position signal 214 from the magnet sensing element 212 to the controller 218, the magnet sensing element 212 may be connected to a printed circuit assembly (PCA) of the print carriage 304. The connection may be, for example, using a cable. The PCA of the print carriage 304 may also be referred to as carriage PCA and may be mounted on a seat 614 of the print carriage 304. The carriage PCA may supply the received position signal 214 to a central PCA of the printing device 400. The central PCA may be same as, or part of, the controller 218.

Although FIGS. 4-6 are explained with reference to examples in which the print carriage 302 is disposed above the media tray 202 and in which the printable medium 102 is conveyed in a C-shaped path from the media tray 202 for printing, the present subject matter can be utilized in printers of other configurations as well. For instance, the present subject matter can be utilized in printing devices in which printable media are conveyed a substantially L-shaped path, as will be explained below:

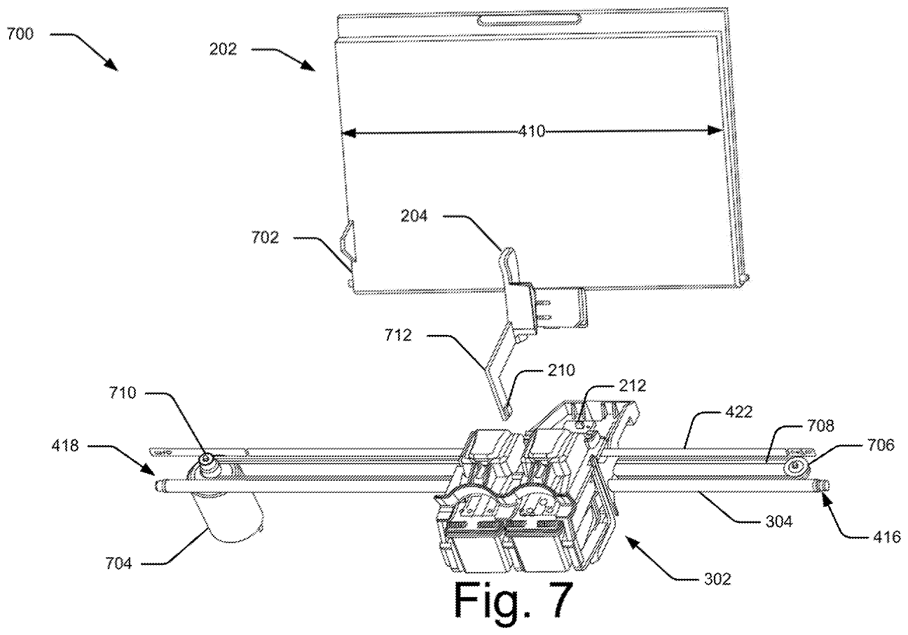

FIG. 7 illustrates a perspective view of a portion of a printing device 700 in which printable media are conveyed in a substantially L-shaped path, according to an example implementation of the present subject matter. The printing device 700 may correspond to the printing device 100. Here, the components that are similar to that of the printing device 100 and the printing device 400 are denoted by the same reference numbers. For instance, the media tray of the printing device 700 is denoted by the reference numeral 202 and the encoder strip of the printing device 700 is denoted by the reference numeral 422. Here, various components of the printing device 700, such as outer cover, chassis, and feed roller, have been obscured.

The printing device 700 includes the media tray 202 on which the printable medium 102 can be received. Here, the media tray 202 may be positioned in a substantially vertical position. Accordingly, a user of the printing device 700 may feed the printable medium 102 in a vertical direction pointing downwards. The printing device 700 also includes the first adjuster leg 204 that is disposed on the media tray 202 and that can move in the lateral direction 410 on the media tray 202. In an example, printing device 700 may include the first adjuster leg 204 alone, and the printable medium 102 may be received, between a lateral end 702 of the media tray 202 and the first adjuster leg 204. In another example, in addition to the first adjuster leg 204, the second adjuster leg 402 may also be disposed on the media tray 202, and the printable medium 102 may be received between the two adjuster legs. In both the examples, the position of the first adjuster leg 204 on the media tray 202 indicates the size of the printable medium 102.

When a print command is received by the printing device 700, to print on the printable medium 102, the printable medium 102 may first be conveyed in a substantially downward direction. Subsequently, the printable medium 102 may be moved under a roller (not shown in FIG. 7) and may be moved in a horizontal direction thereafter. Accordingly, the printable medium 102 is conveyed in a substantially L-shaped path. Thus, the printing device 700 may be referred to as an L-path printing device 700.

The printing device 700 also includes the print carriage 302 and the carriage rod 304. The carriage rod 304 extends parallel to the lateral direction 410 and slidably supports the print carriage 302. Accordingly, the print carriage 302 slides parallel to the lateral direction 410.

To facilitate sliding motion of the print carriage 302, the printing device 700 includes a motor 704, also referred to as the carriage motor 704. The carriage motor 704 may be disposed near the second end 418 of the carriage rod 304. Further, near the first end 416, a pulley 706 may be provided. An endless belt 708 may be coupled to an output shaft 710 of the carriage motor 704 and the pulley 706. Accordingly, the endless belt 708 may travel around the output shaft 710 and the pulley 706 when the carriage motor 704 is rotated. The endless belt 708 may also be coupled to the print carriage 302. Therefore, when the endless belt 708 rotates around the output shaft 710 and the pulley 706, the print carriage 302 slides along the carriage rod 304.

The printing device 700 further includes the magnet 210 and the magnet sensing element 212. The magnet sensing element 212 may be coupled to the print carriage 302 and the magnet 210 may be coupled to the first adjuster leg 204.

To determine the size of the printable medium 102, the magnet sensing element 212 is to sense the magnetic field of the magnet 210, as explained earlier. For this, the magnet 210 and the magnet sensing element 212 are to face each other. However, in the present example, the first adjuster leg 204, to which the magnet 210 is coupled, and the print carriage 302, to which the magnet sensing element 212 is coupled do not face each other. Accordingly, to facilitate the magnet 210 and the magnet sensing element 212 to face each other, the printing device 700 includes an extension element 712, to which the magnet 210 may be coupled. The extension element 712 may extend from the first adjuster leg 204 and may be disposed above a region through which the print carriage 302 passes.

As will be understood, when the magnet 210 and the magnet sensing element 212 are aligned, the magnet 210 is vertically above the magnet sensing element 212, which is different from the arrangement described with reference FIGS. 4-6. Even in such cases, the least value of the sensing distance is obtained when the magnet 210 is vertically above the magnet sensing element 212. Accordingly, the sensing distance is less than the threshold distance for the aligned position.

In an example, the extension element 712 may be an L-shaped bracket. Further, the dimensions of the L-shaped bracket may be such that the magnet 210 faces the magnet sensing element 212 when the print carriage 302 slides along the carriage rod 304. This causes generation of the position signal 214 having the first value. Thus, by determining the distance of the print carriage 302 from the first end 416 at which the first value of position signal 214 is received, the size of the printable medium 102 can be determined, as explained earlier.

To determine the distance of the print carriage 302 from the first end 416, in an example, the printing device 700 includes the encoder strip 422, The encoder strip 422 may run parallel to the carriage rod 304 and a portion of the print carriage 302 may extend rearwardly and over the encoder strip 422.

In an example, to cause the print carriage 302 to slide along the carriage rod 304, in an example, the controller 218 may instruct the motor 704 to rotate. During the sliding of the print carriage 302, the controller 218 may continue to determine position of the print carriage 302 based on signals received from the encoder strip 422. Based on the position, the controller 218 may control movement of the print carriage 302. Thus, a closed-loop control of the movement of the print carriage 304 is achieved.

Although the carriage motor and endless belt are explained with reference to the L-path printing device alone, it will be understood that these components can be used in the C-path printing device as well. Also, although the present subject matter has been explained with the help of examples in which the sensing element is movable relative to the adjuster leg, in some cases, the sensing element may be disposed on the adjuster leg and the position indicator, such as the magnet, may be movable relative to the adjuster leg. In such cases, the first element 110 may be the sensing element and the second element 112 may be the position indicator. Further, although the extension element 712 is explained with reference to the L-path printing device alone, in some cases, the extension element 712 may be used in C-path printing devices facilitate the position indicator and the sensing element to face each other.

Now, the control of the movement of the print carriage 302 by the controller 218 for the determination of the size of the printable medium 102 will be explained.

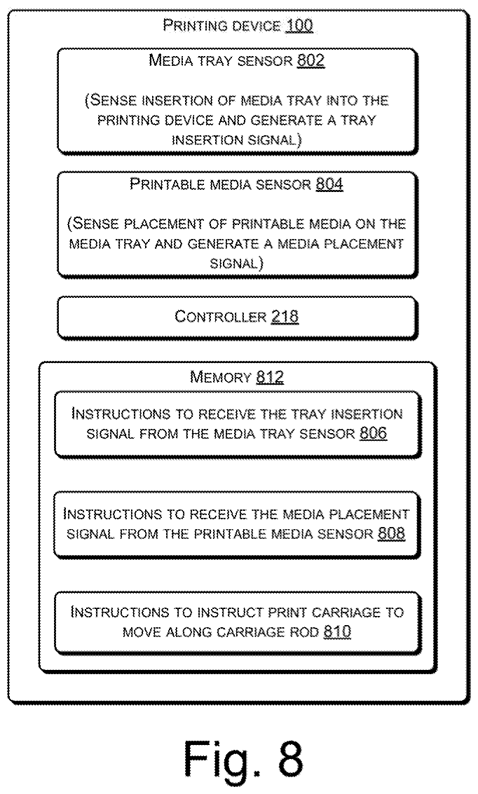

FIG. 8 illustrates the printing device 100 that is to control movement of the print carriage 302, according to an example implementation of the present subject matter.

In an example, the controller 218 causes the print carriage 302 to slide along the carriage rod 304 once the printable medium 102 is placed on the media tray 202 and the first adjuster leg 204 and/or the second adjuster leg 402 are adjusted to be disposed adjacent to the printable medium. To determine that the printable medium 102 is placed and that the adjuster legs are adjusted, the controller 218 utilizes a signal from a sensor. In an example, the sensor may be a media tray sensor 802 that senses or detects insertion of the media tray 202 into the body of the printing device 100. The media tray sensor 802 may be disposed in the body of the printing device 100 and may face the media tray 202 when the media tray 202 is inserted. The media tray sensor 802 may be, for example, an optical sensor. Upon sensing the insertion, the media tray sensor 802 may generate a tray insertion signal. The tray insertion signal may be received by the controller 218.

As explained earlier, the media tray 202 may be inserted into the body of the printing device 100 after placement of the printable medium 102 and adjustment of the adjuster legs. Accordingly, upon the receipt of the tray, insertion signal, the controller 218 may cause the print carriage 302 to slide along the carriage rod 304, The controller 218 may cause sliding of the print carriage 302 by instructing the motor 704 to rotate, as explained earlier.

In another example, the sensor may be a printable media sensor 804 that senses placement of the printable medium 102 on the media tray 202. The printable media sensor 804 may also be disposed in the body of the printing device 100 and may face the media tray 202. The printable media sensor 804 may sense the placement of the printable medium 102 after the media tray 202 with the printable medium 102 is inserted. Upon sensing the printable medium 102, the printable media sensor 804 may generate a media placement signal. The media placement signal may be received by the controller 218. Upon receiving the media placement signal, the controller 218 may cause the print carriage 302 to slide along the carriage rod 304.

In a further example, the controller 218 may cause the print carriage 302 to slide along the carriage rod 304 if any of the tray insertion signal and media placement signal is received. The controller 218 may cause the print carriage 302 to slide along the carriage rod 304 for size determination once after the printing device 100 is powered up.

The receiving of the tray insertion signal, receiving of the media placement signal, and instruction of the print carriage 302 may be performed by, execution of machine-readable instructions (interchangeably referred to as “the instructions”) 806, 808, and 810 respectively. The instructions 806-810 may be, stored in a memory 812 of the printing device 100, The memory 812 may include any non-transitory computer-readable medium including, for example, volatile memory such as RAM, or non-volatile memory such as EPROM, flash memory, and the like.

The sliding of the print carriage 302 along the carriage rod 304 facilitates determination of size of the printable medium, as explained earlier. Upon determining the size of the printable medium, when a print command is received from a computing device, the printing device 100 can print on the printable medium print based on the determined size.

The present subject matter provides for an accurate determination of sizes of printable media. The present subject matter utilizes simple and cost-effective components for the size determination. Since the second element, such as the magnet sensing element, can move relative to the adjuster, a magnitude of the position signal varies during movement of the second element relative to the adjuster. This allows for an accurate size determination without the use of multiple stationary sensors. Further, since the second element is coupled to the print carriage, which is already utilized in printers, a separate component to move the sensing element is not to be provided.

The techniques of the present subject matter can be utilized by printers in scenarios where the printers are to automatically determine the size of the printable medium. In an example, upon determining the size, the printing device may send the size information to a computing device that is to send a print command to the printing device. Accordingly, when the computing device sends the print command, the size information may be included in the print command

Although examples and implementations of present subject matter have been described in language specific to structural features and/or methods, it is to be understood that the present subject matter is not necessarily limited to the specific features or methods described. Rather, the specific features and methods are disclosed and explained in the context of a few example, implementations of the present subject matter.

What is claimed is:

1. A printing device comprising
an adjuster that is movable based on a size of printable medium to be fed to the printing device; and
a position sensing system comprising:
a first element coupled to the adjuster and movable with the adjuster to indicate a position of the adjuster; and
a second element movable relative to the adjuster, wherein the position sensing system is to generate a position signal indicative of a distance between the second element and the first element, the position signal being usable to determine the size of the printable medium.

2. The printing device of claim 1, wherein the first element comprises a magnet and wherein the second element comprises a magnet sensing element that is to:
sense magnetic field from the magnet; and
generate the position signal based on the distance of the magnet sensing element from the magnet.

3. The printing device of claim 1, wherein the second element comprises a magnet and wherein the first element comprises a magnet sensing element that is to:
sense magnetic field from the magnet; and
generate the position signal based on the distance of the magnet sensing element from the magnet.

4. The printing device of claim 1, wherein the second element is coupled to a movable element that is movable relative to the adjuster between a first point and a second point, wherein the position sensing system is to generate a position signal of magnitude equal to a first value in response to the distance between the first element and the second element being less than a threshold distance, and wherein the printing device comprises a controller to:
determine the size of the printable medium based on a distance of the movable element from the first point at which the magnitude of the position signal equaling the first value is received.

5. The printing device of claim 4, wherein the controller is to determine the size of the printable medium based on a look-up table, the look-up table indicating the distance of the movable element from the first point and a size of printable medium corresponding to the distance from the first point.

6. A printing device comprising:
an adjuster leg movable to be disposed adjacent to a side of a printable medium;
a position indicator attached to the adjuster leg to indicate a position of the adjuster leg;
a print carriage slidably mounted on a carriage rod and movable relative to the adjuster leg;
a sensing element coupled to the print carriage to move with the print carriage, wherein the sensing element is to:
sense position of the position indicator; and
generate a position signal based on the sensing; and
a controller to determine a size of the printable medium based on the position signal.

7. The printing device of claim 6, wherein the position indicator is a magnet and the sensing element is a magnet sensing element that is to:
sense magnetic field from the magnet; and
generate the position signal based on a distance between the magnet sensing element and the magnet.

8. The printing device of claim 7, wherein the magnet sensing element is one of: an analog Hall sensor and a digital Hail sensor.

9. The printing device of claim 6, wherein the magnet sensing element is to generate the position signal of a first value in response to a distance between the sensing element and the position indicator being less than a threshold distance and wherein the controller is to determine the size of the printable medium based on a distance of the print carriage from an end of the carriage rod at which a magnitude of the position signal equals the first value.

10. The printing device of claim 6, comprising:
a media tray to feed the printable medium to the printing device, wherein the adjuster leg is disposed on the media tray and is movable along the media tray in a widthwise direction of the media tray, wherein the carriage rod extends parallel to the widthwise direction of the media tray, and wherein the print carriage and the sensing element face the media tray.

11. The printing device of claim 6, comprising:
a media tray to feed the printable medium to the printing device, wherein the adjuster leg is disposed on the media tray and movable along the media tray for being disposed alongside the printable medium;
a media tray sensor to detect insertion of the media tray into the printing device; and
a motor coupled to the print carriage and rotatable to slide the print carriage along the carriage rod, wherein the controller is to instruct the motor to rotate in response to the detection that the media tray is inserted in the printing device, to cause sliding of the print carriage and to determine the size of the printable medium.

12. A printing device comprising:
a media tray to hold a printable medium to be fed to the printing device;
a first adjuster leg disposed on the media tray and movable along the media tray for being disposed alongside the printable medium, wherein a position of the first adjuster leg on the media tray is indicative of a size of the printable medium;
a magnet fixedly coupled to the first adjuster leg;
a magnet sensing element movable relative to the first adjuster leg, wherein the magnet sensing element is to:
sense a magnetic field, from the magnet; and
generate a position signal based on the magnetic field; and
a controller to determine a size of the printable medium based on the position signal.

13. The printing device of claim 12, comprising:
a second adjuster leg disposed on the media tray and interlocked with the first adjuster leg, wherein the first adjuster leg and the second adjuster leg are movable relative to each other in a lateral direction of the media tray, and wherein the magnetic sensing element is movable in a direction parallel to the lateral direction.

14. The printing device of claim 12, comprising:
a print carriage that is to carry print cartridge and that is to slide along a carriage rod, wherein the magnet sensing element is coupled to the print carriage.

15. The printing device of claim 14, comprising an extension element that couples the first adjuster leg and the magnet such that the magnet faces the magnet sensing element during movement of the magnet sensing element on the carriage rod.
